(19) United States
(12) Patent Application Publication
(10) Pub. No.: US 2017/0168995 A1
(43) Pub. Date: Jun. 15, 2017

(54) BLOCK CONFIGURATION, A METHOD OF PRESENTING, SERVERS, TERMINAL EQUIPMENT AND COMMUNICATIONS SYSTEMS

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Jiahan WU, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,259

(22) Filed: Aug. 19, 2016

Related U.S. Application Data
(63) Continuation of application No. PCT/CN2016/089558, filed on Jul. 10, 2016.

(30) Foreign Application Priority Data
Dec. 10, 2015 (CN) 201510918629.9

(51) Int. Cl. G06F 17/21; G06F 17/30; G06F 17/22

(52) U.S. Cl. CPC G06F 17/212; G06F 17/2247; G06F 17/2205; G06F 17/30923; G06F 17/30896

(57) ABSTRACT

Embodiments of the present disclosure provide a cell configuration and presentation method, and a terminal. The method includes: in response to a cell configuration request sent by a terminal device, selecting, from a local cell style library, cell configuration parameters of a plurality of cells; and sending the selected cell configuration parameters to the terminal device, such that the terminal device draws cell images according to the cell configuration parameters. With the technical solutions of the present disclosure, configuration parameters of cells may be flexibly set on a server and cells can be flexibly drawn on a terminal device for presentation.

### CROSS-REFERENCE TO RELATED APPLICATIONS

The present disclosure is a continuation application of PCT application No. PCT/CN2016/089558 submitted on Jul. 10, 2016. This application is based upon and claims priority from Chinese Patent Application No. 201510918629.9, entitled “CELL CONFIGURATION AND PRESENTATION METHOD, SERVER, TERMINAL DEVICE, AND COMMUNICATIONS SYSTEM”, filed on Nov. 10, 2015, the entire contents of which are incorporated herein by reference.

### TECHNICAL FIELD

This disclosure relates to information processing technologies, and more particularly, to a cell configuration and presentation method, and.

### BACKGROUND

A concept of cells refers to, for example, in a video disclosure, display cells obtained by dividing all videos according to different categories, for example, movies, sports, news, or variety shows. Each category may be considered as a cell, and each cell generally occupies display space, and is provided with pictures and/or text; after clicking to enter, a user may see a next-level cell or directly watch video content included in the cell. Presentation configuration in cells of the video disclosure is uniformly hardcoded in a configuration file; the video disclosure of the same version has a fixed number of cells, styles, and corresponding categories. Updates need to be performed in a software disclosure of a next version so as to change a presentation form of cells.

### SUMMARY

Embodiments of the present disclosure provide a cell configuration and presentation method, and a terminal, such that configuration parameters of cells can be flexibly set on a server and cells can be flexibly drawn on a terminal device for presentation.

According to a first aspect, an embodiment of an embodiment of the present disclosure provides a cell configuration method. The method includes: in response to a cell configuration request sent by a terminal device, selecting, from a local cell style library, cell configuration parameters of a plurality of cells; and sending the selected cell configuration parameters to the terminal device, such that the terminal device draws cell images according to the cell configuration parameters.

According to a second aspect, an embodiment of the present disclosure further provides a cell presentation method. The method includes: sending a cell configuration request to a server; receiving cell configuration parameters, which are selected from a local cell style library of the server, of a plurality of cells and are sent by the server; and drawing a presentation cell image on an interface of the terminal device according to the cell configuration parameters.

According to a third aspect, an embodiment of this disclosure further provides a terminal, including: at least one processor; and a memory communicably connected with the at least one processor for storing instructions executable by the at least one processor, where execution of the instructions by the at least one processor causes the at least one processor to: send a block configuration request to a server; receive block configuration parameters, which are selected from a local block style library of the server, of multiple blocks and are sent by the server; and draw a presentation block image on an interface of the terminal device according to the block configuration parameters.

### BRIEF DESCRIPTION OF THE DRAWINGS

One or more embodiments are exemplarily described by figures corresponding thereto in the accompanying drawings; the exemplary descriptions do not constitute a limitation on the embodiments. Elements with the same reference numbers in the accompanying drawings are similar elements. Unless otherwise particularly stated, the figures in the accompanying drawings do not constitute a scale limitation.

FIG. 1 is a flowchart illustrating a cell configuration method according to Embodiment 1 of the present disclosure;

FIG. 2 is a schematic exemplary diagram illustrating presentation size parameters of cells provided in Embodiment 1 of the present disclosure;

FIG. 3 is a schematic exemplary diagram illustrating layout parameters of element images of cells according to Embodiment 1 of the present disclosure;

FIG. 4 is a flowchart illustrating a cell presentation method according to Embodiment 2 of the present disclosure;

FIG. 5 is a structural cell diagram illustrating a server according to Embodiment 3 of the present disclosure;

FIG. 6 is a structural cell diagram illustrating a terminal device according to Embodiment 4 of the present disclosure; and

FIG. 7 is a schematic structural diagram of hardware of a server for executing a cell configuration method provided in Embodiment 7 of this disclosure; and

FIG. 8 is a schematic structural diagram of hardware of a terminal for executing a cell presentation method provided in Embodiment 8 of this disclosure.

### DETAILED DESCRIPTION

A basic inventive concept of some embodiments of the present disclosure is that a server flexibly sets configuration parameters of cells and delivers the configuration parameters to a terminal device, and the terminal device draws cells for presentation. The present solution is applicable to page configuration of all cells in an existing client, and specific cell styles can be configured and adjusted by corresponding background servers.

### Embodiment 1

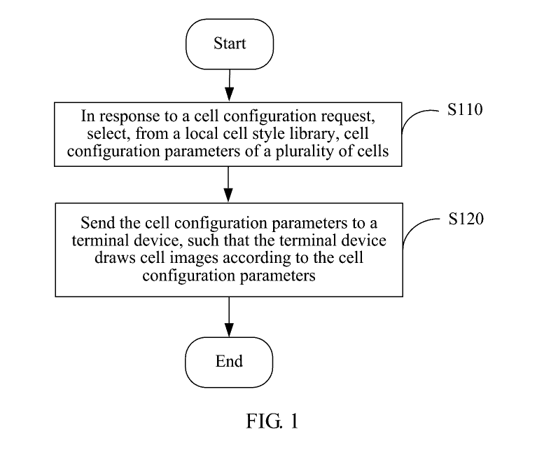

FIG. 1 is a method flowchart illustrating a cell configuration method according to an embodiment of the present disclosure. An enforcement object of the method may be a server.

With reference to FIG. 1, in step S110, in response to a cell configuration request sent a terminal device selects, from a local cell style library, cell configuration parameters of a plurality of cells.

Generally, after a user opens, for example, a video disclosure on a terminal device; if in a networking state, the terminal device triggers the video disclosure to be connected to a corresponding server, and asks the server for a parameter for presenting a video disclosure image and a video material. In the prior art, the terminal reads configuration parameters for drawing cell images from a local configuration file when the disclosure is opened. The configuration parameters are generally hardcoded in a disclosure program, and the configuration parameters of cells may be modified only after the video disclosure is updated. Different from a process of acquiring cell configuration parameters on a side of the terminal device in the prior art, in the present implementation, after the disclosure of the terminal device is connected to a back-end server, the terminal device sends a cell configuration request to the server, so as to acquire parameters for configuring the cell images from the server.

Upon receiving the cell configuration request sent by the terminal device, the server selects, from a local cell style library of the server, cell configuration parameters of a plurality of cells. The cell configuration parameters may include presentation size parameters of the cells and layout parameters of element images in the cells. Table 1 lists the presentation size parameters of the cells. Table 2 lists the layout parameters of the element images in the cells.

TABLE 1
Presentation size parameters of cells

| | Description |
|---|---|
| sectionHeaderSpace | Used to indicate a display type of a cell header |
| sectionHeaderHeight | Used to indicate a height of the cell header |
| sectionColumn | The maximum number of columns of each row |
| | displayed in cells, and wrapping is performed |
| | if the value is exceeded |
| rowHeight | A maximum height of each row in the cells |
| cellMaxRowCount | Whether arranged vertically or horizontally, |
| | and the maximum number of rows when arranged |
| | vertically in a case of being greater than 0 |

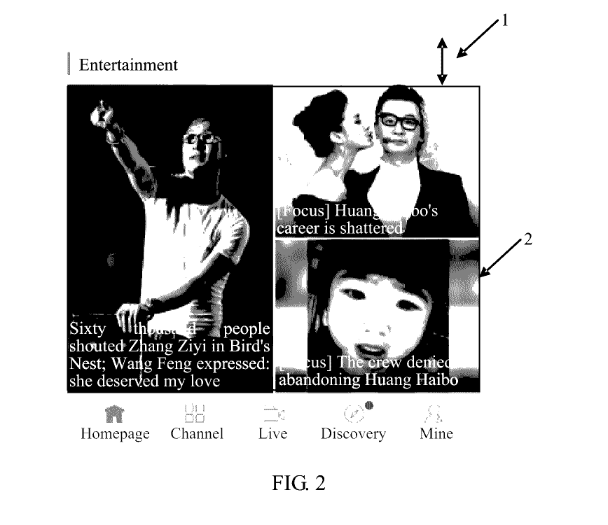

Specifically, as illustrated in FIG. 2, parameters listed in Table 1 are described with reference to iconography.

1: sectionHeaderHeight: 30

sectionHeaderSpace: hearder_1

Explanation: a height of the header is 30, and a display type of hearder_1 is used

2: rowHeight: 284

cellMaxRowCount: 2

sectionColumn: 2

Explanation: sectionColumn: cells are displayed into two columns at most

When cellMaxRowCount is 2, it indicates that cells are arranged vertically into two rows at most; when cellMaxRowCount is 0, it indicates horizontal arrangement, and that a client arranges element images in the cells from a left-most side of a screen to a right-most side, and performs wrapping automatically when the element images cannot be accommodated in one row; when cellMaxRowCount is greater than 0, it indicates vertical arrangement, and that the client starts to arrange the element images from an upper side of the screen to a lower side; if an accumulated height reaches rowHeight, the client starts to arrange the element images to a right side, and then calculates a width after arrangement, so as to determine whether to arrange the cells vertically or perform wrapping.

When rowHeight is 284, it indicates that a maximum height of each group during vertical arrangement is 284, and when the height exceeds 284, the element images are arranged horizontally to the right, and if a width of the screen is exceeded, wrapping is performed.

The server can convert the above presentation size parameters of the cells into JSON data, and then deliver the JSON data to the terminal device.

TABLE 2
Layout parameters of element images in cells (cellSpace)

| | |
|---|---|
| cell_1x2_left | Vertical arrangement occupies two rows of grids |
| cell_1x1_left | Left-most side of two or three columns |
| cell_1x2_right | Right-most side of two or three columns |
| cell_1x1_center | Middle of three columns |
| cell_2x1 | Two columns of grids occupy one row |
| cell_3x1 | Three columns of grids occupy one row |

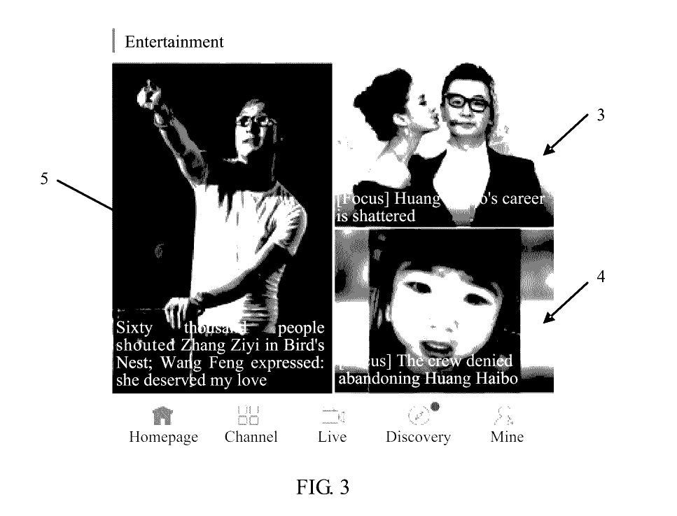

Specifically, as illustrated in FIG. 3, parameters listed in Table 2 are described with reference to iconography.

3: cell_1×1 right: right-most side of two or three columns;

4: cell_1×1 right: right-most side of two or three columns;

5: cell_1×2 left: left-most side of two or three columns.

In specific parameter configuration, types of the layout parameters of the element images in the cells can be specified by setting cellSpace parameters. The server can convert the layout parameters of the element images of the cells into XML file data, and then deliver the XML file data to the terminal device.

In specific disclosure scenarios, when selecting the cell configuration parameters of the cells, the server can perform selection according to preset rules, and the cell configuration parameters pre-stored in the cell style library can be also periodically modified, replaced, or added.

In step S120, the selected cell configuration parameters is sent to the terminal device, such that the terminal device draws cell images according to the cell configuration parameters.

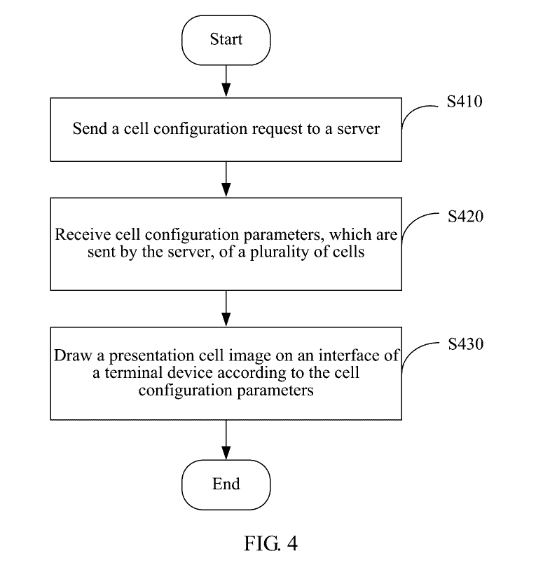

A drawing operation process of drawing the cell images on the terminal device according to the cell configuration parameters is preset in the terminal device, for example, a PageCard (a program dedicated in drawing the cell images) operation process in a client disclosure is invoked; see corresponding content of the embodiment shown in FIG. 4 for a specific drawing process, and details are not described herein again.

According to the media content play method provided in this embodiment of the present disclosure, on the basis that an existing terminal device side draws cell images according to local cell configuration parameters that are fixedly set, configuration parameters of cells are transferred to a side of a server, and after a client of the terminal device side is linked to the server each time, the server delivers the cell configuration parameters to the terminal device, so as to complete drawing the cell images. In this way, maintainers can flexibly draw the cell images with more abundant content styles on the terminal device side by flexibly modifying the cell configuration parameters on the side of the server.

### Embodiment 2

FIG. 4 is a method flowchart illustrating a cell presentation method according to an embodiment of the present disclosure. An enforcement object of the method may be a terminal device corresponding to the server in FIG. 1.

With reference to FIG. 4, in step S410, a cell configuration request is sent to a server.

Generally, after a user opens, for example, a video disclosure on a terminal device; if in a networking state, the terminal device triggers the video disclosure to be connected to a corresponding server, and asks the server for a parameter for presenting a video disclosure image and a video material. In the prior art, the terminal device reads configuration parameters for drawing cell images from a local configuration file when the disclosure is opened. The configuration parameters are generally hardcoded in a disclosure program, and the configuration parameters of cells may be modified only after the video disclosure is updated. Different from a process of acquiring cell configuration parameters on a side of the terminal device in the prior art, in the present implementation, after the disclosure of the terminal device is connected to a back-end server, the terminal device sends a cell configuration request to the server, so as to acquire parameters for configuring the cell images from the server.

Specifically, a triggering form of acquiring the cell configuration parameters by a client may be sending specified information for requesting for the cell configuration parameters; or the terminal device and the server may pre-appoint events of requesting the server to deliver the cell configuration parameters; when the terminal device executes the events and the execution is sensed by the server, the server selects, from a local cell style library, the cell configuration parameters of a plurality of cells for delivery. For example, the terminal device and the server may pre-appoint that when the disclosure of the terminal device is opened and is connected to the server, the server directly delivers the cell configuration parameters; for another example, sending a request similar to a link request to the server may be also considered as the pre-appointed event to request the server to deliver the cell configuration parameters. This embodiment makes no limitation to specific triggering forms of acquiring the cell configuration parameters.

In step S420, cell configuration parameters are received, which are selected from a local cell style library of the server, of a plurality of cells and are sent by the server.

Reference may be made to step S110 for content of selecting the cell configuration parameters by the server. The cell configuration parameters may include presentation size parameters of the cells and layout parameters of element images in the cells.

In step S430, a presentation cell image is drawn on an interface of the terminal device according to the cell configuration parameters.

Upon receiving the cell configuration parameters delivered by the server, the terminal device invokes a cell drawing operation process, for example, a PageCard operation process (a program code) integrated on the terminal device, and draws the presentation cell image on the interface of the terminal device according to the presentation size parameters of the cells and the layout parameters of the element images in the cells included in the cell configuration parameters. In the PageCard operation process, for each type of

Specifically, when drawing the cell images, the terminal device reads JSON data and an XML file in the cell configuration parameters, and draws the cell images by using a predefined corresponding read drawing specification in the PageCard. For example, the terminal device needs to set a presentation size and a presentation location, which are on an disclosure interface, of each cell, and calculate a location, where the element image (list) in each cell is displayed, on the interface, and whether the element image is displayed on a left side or a right side; and whether the element image is displayed on an upper side or a lower side are determined. The terminal device also needs to calculate a size of space occupied by the current element image, whether 1×1 or 1×2. The configuration processes need match between content of •cellSpace and a name of an interface configuration file xml in the client.

Further, for the element image in each cell, the client may acquire locally or from the server, material pictures of the element image in each cell, and draw the material pictures in a display area of the element image in the corresponding each cell. Modifications, for example, size modification need to be adaptively performed on the material pictures when the element image is drawn, so as to be adapted to an element image layout type in each cell.

According to the cell presentation method provided in this embodiment of the present disclosure, on the basis that an existing terminal device side draws cell images according to local cell configuration parameters that are fixedly set, configuration parameters of cells are transferred to a side of a server, and after a client of the terminal device side is linked to the server each time, the cell configuration parameters are acquired, and the cell images are drawn. In this way, maintainers can flexibly draw the cell images with more abundant content styles can be flexibly drawn on the terminal device side by flexibly modifying the cell configuration parameters on the side of the server.

### Embodiment 3

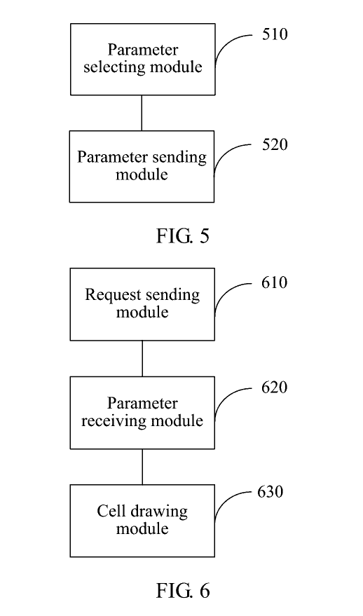

FIG. 5 is a structural cell diagram illustrating a server according to an embodiment the present disclosure, where the cell configuration apparatus is applied on a server end, and may be used to perform the method steps of the embodiment as illustrated in FIG. 1.

With reference to FIG. 5, the cell configuration apparatus specifically includes: a parameter selecting module 510 and a parameter sending module 520.

The parameter selecting module 510 is configured to: in response to a cell configuration request sent by a terminal device, select, from a local cell style library, cell configuration parameters of a plurality of cells; and the parameter sending module 520 is configured to send the selected cell configuration parameters to the terminal device, such that the terminal device draws cell images according to the cell configuration parameters.

Further, the cell configuration parameters include presentation size parameters of the cells and layout parameters of element images in the cells.

Further, the presentation size parameters of the cells are JSON data and/or the layout parameters of the element images in the cells are XML file data.

On such basis, the parameter selecting module 510 is further configured to: in response to an event executed by the terminal device to request a server to deliver the cell configuration parameters, select, from the local cell style library, the cell configuration parameters of the plurality of cells.

According to the cell configuration apparatus provided in this embodiment of the present disclosure, on the basis that an existing terminal device side draws cell images according to local cell configuration parameters that are fixedly set, configuration parameters of cells are transferred to a side of the server, and after a client of the terminal device side is linked to the server each time, the server delivers the cell configuration parameters to the terminal device, so as to complete drawing the cell images. In this way, maintainers can flexibly draw the cell images with more abundant content styles can be flexibly drawn on the terminal device side by flexibly modifying the cell configuration parameters on the side of the server.

### Embodiment 4

FIG. 6 is a structural cell diagram of an embodiment of a cell presentation apparatus provided in the present disclosure, and the terminal device can be used to execute the method steps of the embodiment shown in FIG. 4.

With reference to FIG. 6, the terminal device specifically includes: a request sending module 610, a parameter receiving module 620, and a cell drawing module 630.

The request sending module 610 is configured to send a cell configuration request to a server; the parameter receiving module 620 is configured to receive cell configuration parameters, which are selected from a local cell style library of the server, of a plurality of cells and are sent by the server; and the cell drawing module 630 is configured to draw a presentation cell image on an interface of the terminal device according to the cell configuration parameters.

Further, the cell configuration parameters include presentation size parameters of the cells and layout parameters of element images in the cells. On such basis, the cell drawing module 630 is specifically configured to: invoke a cell drawing operation process, and draw the presentation cell image on the interface of the terminal device according to the presentation size parameters of the cells and the layout parameters of the element images in the cells included in the cell configuration parameters.

Further, the presentation size parameters of the cells are JSON data and/or the layout parameters of the element images in the cells are XML file data.

Optionally, the cell drawing module 630 is further configured to: acquire, locally or from the server, material pictures of the element images in the cells, and draw the material pictures in display areas of the element images of the corresponding cells.

Further, the terminal device further includes an event executing module, configured to execute an event to request the server to deliver the cell configuration parameters.

According to the cell presentation apparatus provided in this embodiment of the present disclosure, on the basis that an existing terminal device side draws cell images according to local cell configuration parameters that are fixedly set, configuration parameters of cells are transferred to a side of a server, and after a client of the terminal device side is linked to the server each time, the cell configuration parameters are acquired, and the cell images are drawn. In this way, maintainers can flexibly draw the cell images with more abundant content styles can be flexibly drawn on the terminal device side by flexibly modifying the cell configuration parameters on the side of the server.

On such basis, the present disclosure further provides a communications system, which includes the cell configuration apparatus shown in FIG. 5 and the terminal device shown in FIG. 6.

### Embodiment 5

Correspondingly, embodiment 5 of this disclosure provides a non-transitory computer-readable storage medium, which stores a computer executable instruction, where the computer executable instruction can execute the cell presentation method in the foregoing embodiment 1.

### Embodiment 6

Correspondingly, embodiment 6 this disclosure provides a non-transitory computer-readable storage medium, which stores a computer executable instruction, where the computer executable instruction can execute the cell presentation method in the foregoing embodiment 2.

### Embodiment 7

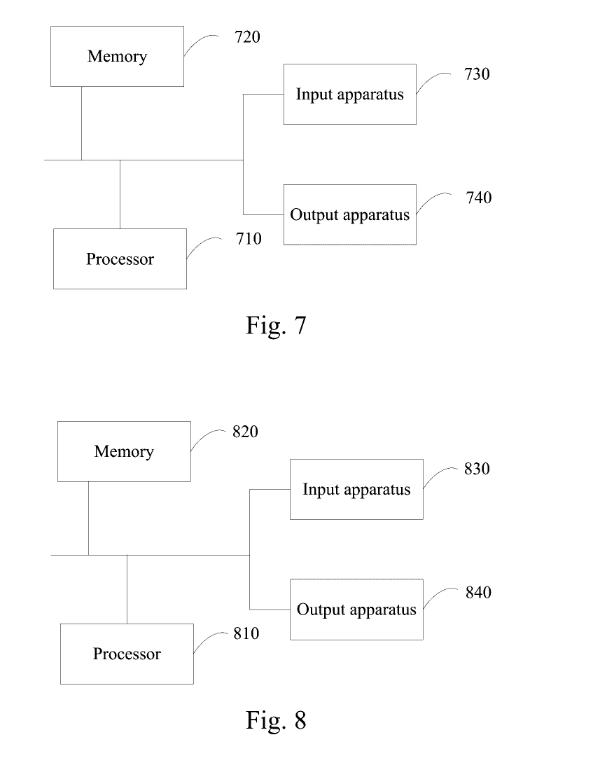

FIG. 7 is a schematic structural diagram of hardware of an electronic device for executing a cell configuration method provided in Embodiment 7 of this disclosure. As shown in FIG. 7, the device includes: one or more processors 710 and a memory 720, where one processor 710 is used as an example in FIG. 7.

A device for executing the cell configuration method may further include: an input apparatus 730 and an output apparatus 740.

The processor 710, the memory 720, the input apparatus 730, and the output apparatus 740 can be connected by means of a bus or in other manners. A connection by means of a bus is used as an example in FIG. 7.

As a non-transitory computer-readable storage medium, the memory 720 can be used to store non-volatile software programs, non-volatile computer executable programs and modules, for example, a program instruction/module corresponding to the cell configuration method in the embodiments of this disclosure (for example, the parameter selection module 510 and the parameter sending module 520 shown in FIG. 5). The processor 710 executes various functional disclosures and data processing of the server, that is, implements the cell configuration method of the foregoing method embodiments, by running the non-transitory software programs, instructions, and modules that are stored in the memory 720.

The memory 720 may include a program storage area and a data storage area, where the program storage area may store an operating system and an disclosure that is needed by at least one function; the data storage area may store data created according to use of the cell configuration apparatus, and the like. In addition, the memory 720 may include a high-speed random access memory, or may also include a non-transitory memory such as at least one disk storage device, flash storage device, or another non-volatile solid-state storage device. In some embodiments, the memory 720 optionally includes memories that are remotely disposed with respect to the processor 710, and the remote memories may be connected, via a network, to the cell configuration apparatus. Examples of the foregoing network include but are not limited to: the Internet, an intranet, a local area network, a mobile communications network, or a combination thereof.

The input apparatus 730 can receive entered digits or character information, and generate key signal inputs relevant to user setting and functional control of the cell configuration apparatus. The output apparatus 740 may include a display device, for example, a display screen.

The one or more modules are stored in the memory 720; when the one or more modules are executed by the one or more processors 710, the cell configuration method in any one of the foregoing method embodiments is executed.

### Embodiment 8

FIG. 8 is a schematic structural diagram of hardware of a terminal for executing a cell presentation method provided in Embodiment 7 of this disclosure. As shown in FIG. 8, the device includes: one or more processors 810 and a memory 820, where only one processor 810 is used as an example in FIG. 8.

A device for executing the cell presentation method may further include: an input apparatus 830 and an output apparatus 840.

The processor 810, the memory 820, the input apparatus 830, and the output apparatus 840 can be connected by means of a bus or in other manners. A connection by means of a bus is used as an example in FIG. 8.

As a non-transitory computer-readable storage medium, the memory 820 can be used to store non-transitory software programs, non-transitory computer-readable executable programs and modules, for example, a program instruction/module corresponding to the cell presentation method in the embodiments of this disclosure (for example, the request sending module 610, the parameter receiving module 620, and the cell drawing module 630 shown in FIG. 6). The processor 810 executes various functional disclosures and data processing of the server, that is, implements the cell presentation method of the foregoing method embodiments, by running the non-transitory software programs, instructions, and modules that are stored in the memory 820.

The memory 820 may include a program storage area and a data storage area, where the program storage area may store an operating system and an disclosure that is needed by at least one function; the data storage area may store data created according to use of the cell configuration apparatus, and the like. In addition, the memory 820 may include a high-speed random access memory, or may also include a non-transitory memory such as at least one disk storage device, flash storage device, or another non-transitory solid-state storage device. In some embodiments, the memory 820 optionally includes memories that are remotely disposed with respect to the processor 810, and the remote memories may be connected, via a network, to the cell presentation apparatus. Examples of the foregoing network include but are not limited to: the Internet, an intranet, a local area network, a mobile communications network, or a combination thereof.

The input apparatus 830 can receive entered digits or character information, and generate key signal inputs relevant to user setting and functional control of the cell configuration apparatus. The output apparatus 840 may include a display device, for example, a display screen.

The one or more modules are stored in the memory 820; when the one or more modules are executed by the one or more processors 810, the cell presentation method in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

What is claimed is:

1. A cell configuration method, applied to a server, comprising:
in response to a cell configuration request sent by a terminal device, selecting, from a local cell style library, cell configuration parameters of a plurality of cells; and
sending the selected cell configuration parameters to the terminal device, such that the terminal device draws cell images according to the cell configuration parameters.

2. The method according to claim 1, wherein the cell configuration parameters comprise presentation size parameters of the cells and layout parameters of element images in the cells.

3. The method according to claim 2, wherein the presentation size parameters of the cells are JSON data and/or the layout parameters of the element images in the cells are XML file data.

4. The method according to claim 1, further comprising:
in response to an event executed by the terminal device to request a server to deliver the cell configuration parameters, selecting, from the local cell style library, the cell configuration parameters of the plurality of cells.

5. A cell presentation method, applied to a terminal device, comprising:
sending a cell configuration request to a server;
receiving cell configuration parameters, which are selected from a local cell style library of the server, of a plurality of cells and are sent by the server; and
drawing a presentation cell image on an interface of the terminal device according to the cell configuration parameters.

6. The method according to claim 5, wherein the cell configuration parameters comprise presentation size parameters of the cells and layout parameters of element images in the cells.

7. The method according to claim 6, wherein the drawing a presentation cell image on an interface of the terminal device according to the cell configuration parameters comprises: invoking a cell drawing operation process, and drawing the presentation cell image on the interface of the terminal device according to the presentation size parameters of the cells and the layout parameters of the element images in the cells included in the cell configuration parameters.

8. The method according to claim 6, wherein the presentation size parameters of the cells are JSON data and/or the layout parameters of the element images in the cells are XML file data.

9. The method according to claim 5, further comprising:
acquiring, locally or from the server, material pictures of the element images in the cells, and drawing the material pictures in display areas of the element images of the corresponding cells.

10. The method according to claim 5, further comprising:
executing an event to request the server to deliver the cell configuration parameters.

11. A terminal, comprising:
at least one processor; and
a memory communicably connected with the at least one processor for storing instructions executable by the at least one processor, where execution of the instructions by the at least one processor causes the at least one processor to:
send a cell configuration request to a server;
receive cell configuration parameters, which are selected from a local cell style library of the server, of multiple cells and are sent by the server; and
draw a presentation cell image on an interface of the terminal device according to the cell configuration parameters.

12. The terminal according to claim 11, wherein the cell configuration parameters comprise presentation size parameters of the cells and layout parameters of element images in the cells.

13. The terminal according to claim 12, wherein to draw a presentation cell image on an interface of the terminal device according to the cell configuration parameters the at least one processor to is caused to: invoke a cell drawing operation process, and draw the presentation cell image on the interface of the terminal device according to the presentation size parameters of the cells and the layout parameters of the lists in the cells included in the cell configuration parameters.

14. The server according to claim 12, wherein the presentation size parameters of the cells are JSON data and/or the layout parameters of the lists in the cells are XML file data.

15. The terminal according to claim 11, wherein the at least one processor is further caused to:
acquire, locally or from an end of the server, material pictures of the lists in the cells, and draw the material pictures in display areas of the lists of the corresponding cells.

16. The terminal device according to claim 11, wherein the at least one processor is further caused to:
execute an event of requesting the server to deliver the cell configuration parameters.
